(19) United States
(12) Patent Application Publication
(10) Pub. No.: US 2005/0199176 A1
(43) Pub. Date: Sep. 15, 2005

(54) Anti-wrap system and device

(76) Inventors: Joseph R. Orton, Findlay, OH (US); Robert R. Carpenter, Liberty Center, OH (US)

Correspondence Address: MARSHALL & MELHORN, FOUR SEAGATE, EIGHT FLOOR, TOLEDO, OH, 43604, US

(21) Appl. No.: 11/075,606

(22) Filed: Mar. 9, 2005

Related U.S. Application Data
(60) Provisional application No. 60/551,597, filed on Mar. 9, 2004.

(51) Int. Cl. G09F 17/00

(52) U.S. Cl. 116/174

(57) ABSTRACT

An anti-wrap device for a flag comprises a clamp, which is configured to attach the anti-wrap device to a flagpole. The clamp includes a pair of spaced apart arms and a connecting portion, connecting the pair of spaced apart arms, with a first pivot disposed between the pair of spaced apart arms. An arm hinge is rotatably disposed about the first pivot, and configured to have a limited and predetermined range of motion about the first pivot. A second pivot is disposed through said arm hinge, with a flag arm comprising first and second spaced apart retaining arms that are connected together by a connecting portion. The retaining arms are configured to be disposed on either major face of a flag and are pivotable about the second pivot in a direction substantially orthogonal to the direction of pivot of the am hinge about the first pivot.

### RELATED APPLICATIONS

This application is claiming the benefit, under 35 U.S.C. § 119(e), of the provisional application filed Mar. 9, 2004 under 35 U.S.C. § 111 (b), which was granted Ser. No. 60/551,597. This provisional application is hereby incorporated by reference. Application Ser. No. 60/551,597 is co-pending as of the filing date of the present application.

### BACKGROUND OF THE INVENTION

The present invention relates to a system and apparatus for hanging banners, flags and the like. More specifically, the present invention relates to a system and apparatus of the foregoing nature, which is specifically designed to prevent a flag or a banner mounted on a pole from fouling or wrapping around the pole in windy conditions. Most specifically, the present invention relates to a system or apparatus comprising at least a fixed hinge mountable to flagpoles of widely varying diameters, an arm hinge pivotally mounted to the fixed hinge for horizontal movement through less than 360° of rotation, and an arm member having a pair of arms, the arms for placement one on each side of a flag mounted to the flag pole and pivotally mounted to the arm hinge for rotation through about ninety degrees in a plane orthogonal to the plane in which the arm hinge rotates.

The problems of having a banner or flag foul, or wrap around the pole on which it has been mounted has existed almost from the time of the invention of the flag. Many solutions to this problem have been tried by Applicant and others over the years. Many of these solutions, such as that shown in U.S. Pat. No. 5,255,627 to Williams, show devices which mount to only one size flagpole, and must be actually attached to the flag to be operational. While such a device is generally satisfactory, applicant sought to make an anti-wrap device which would not need to be attached to the flag, thereby eliminating the problem of wear and possibly ripping the flag under windy conditions. Additionally, it was desired to provide a device that could be mounted to many diameters of flagpole, and which could be mounted in any desired position with respect to a flag, for example, near the middle of the flag.

### SUMMARY OF THE INVENTION

In view of the above, it is a possible object of the present invention to provide a flag anti-wrap device, which is adjustably mountable to a wide range of flagpole diameters.

A further possible object of the present invention is to provide a flag anti-wrap device, which is easily retrofitted to existing flags on existing flagpoles.

A still further possible object is to provide a flag anti-wrap device, which is able to prevent fouling of a flag or banner without actual attachment to the flag or banner.

Another possible object is to provide a flag anti-wrap device which can be mounted to a flagpole at any desired position between the top and the bottom of the flag and still prevent fouling.

Yet another possible object is to provide a flag anti-wrap device apparatus comprising at least a fixed hinge mountable to flagpoles of widely varying diameters, an arm hinge pivotally mounted to the fixed hinge for horizontal movement through less than 360° of rotation, and an arm member having a pair of arms, each of the arms for placement on one side of a flag mounted to the flag pole, pivotally mounted to the arm hinge for rotation through about ninety degrees.

### BRIEF DESCRIPTION OF THE DRAWINGS

The advantages of the invention will become readily apparent to those skilled in the art from the following detailed description of a preferred embodiment when considered in the light of the accompanying drawings, in which:

FIG. 1. is a front, elevational, perspective view, partially cut away, of a prior art device.

FIG. 1A is a rear, elevational, perspective view, partially cut away, of a prior art device.

FIG. 2. is an elevational view of a construction embodying the present invention.

FIG. 2A is an enlarged view, partially cut away, of the construction shown in FIG. 2.

FIG. 3. is an exploded view of the flag anti-wrap device shown in FIG. 2A.

FIG. 4. is an elevational view of the arm member of the flag anti-wrap device shown in FIG. 3.

FIG. 5 is a plain view of the arm member shown in FIG. 4.

FIG. 6 is a perspective view of a universal pole latch.

FIG. 7 is a sectional view, taken in the direction of the arrows, along the section line 7-7 of FIG. 8.

FIG. 8 is an elevational view of a clamping portion in accordance with an embodiment of the present invention.

FIG. 9 is a left end view of the construction shown in FIG. 8.

FIG. 10 is a top view of the hinged portion in accordance with an embodiment of the present invention.

FIG. 11 is an elevational view of the construction shown in FIG. 10.

FIG. 12 is an end view of the construction shown in FIG. 10.

FIG. 13 is a perspective view of an arm hinge arm in accordance with an embodiment of the present invention.

FIG. 14 is a sectional view, taken in the direction of the arrows, along the section line 14-14 of FIG. 13.

FIG. 15 is a bottom view, partially cut away, of the construction shown in FIG. 13.

FIG. 16 is a sectional view, taken in the direction of the arrows, along the section line 16-16 of FIG. 13.

### DESCRIPTION OF THE PREFERRED EMBODIMENT

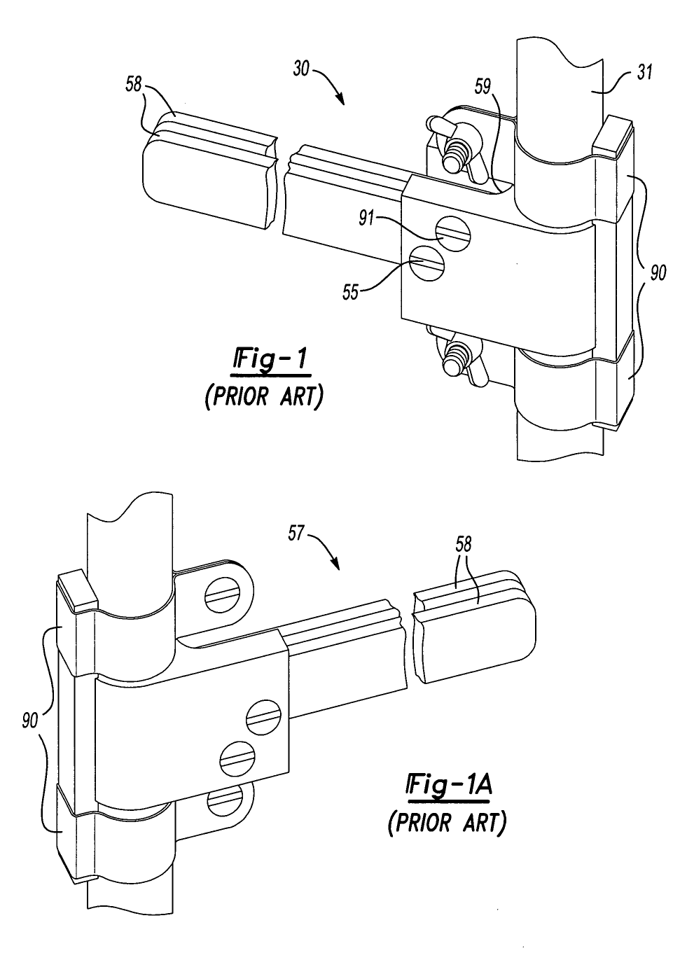

Referring to FIGS. 1 and 1A, there is shown a known flag anti-wrap system, generally designated by the numeral 30, for preventing a flag or banner (not shown) from wrapping around the pole 31 on which it is mounted. In this embodiment, the anti-wrap device can be secured to the flagpole through the use of clamps 90, which can be disposed above and below the anti-wrap device on the flagpole. The flag anti-wrap device will rotate about the flagpole 31, while the flag retaining arm 58 will rotate about a pin 55. The motion of the flag-retaining arm 58 can be limited through the use of a stop pin 91 disposed in the flag anti-wrap device. The rotation of the anti-wrap device 30 about the flagpole 32 has caused problems in the art which have been solved by the present invention.

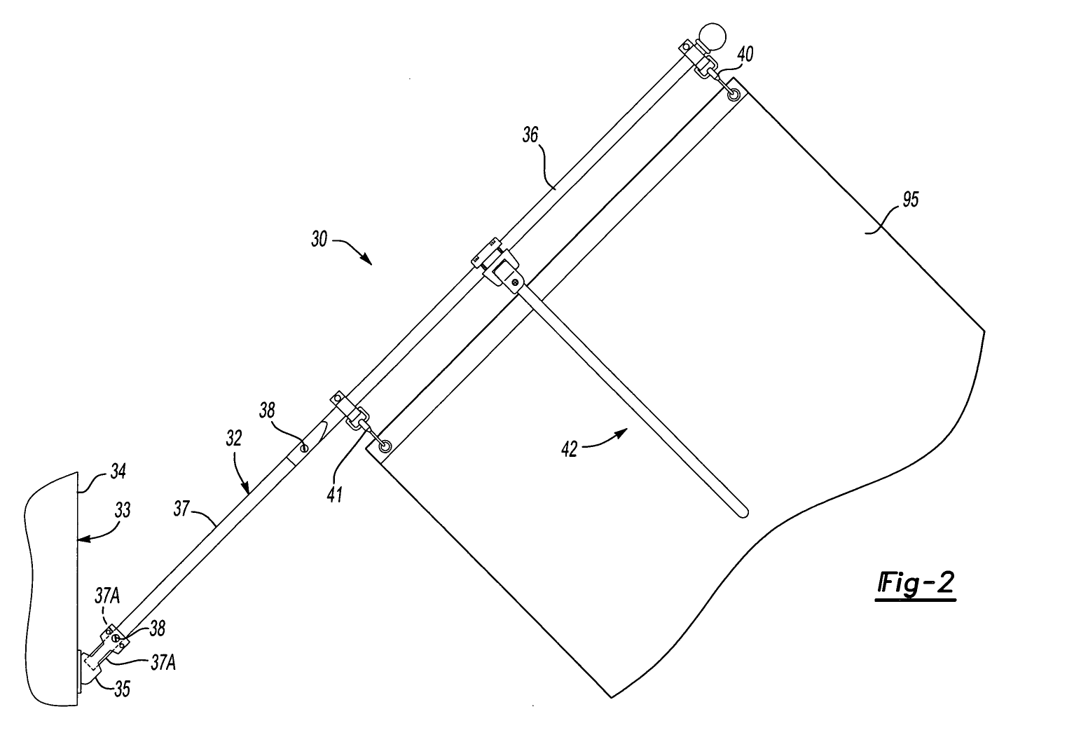

Referring now to FIG. 2, a flag anti-wrap device 42 according to the present invention is described. A flag pole 32 is illustrated, which may be mounted to a support, generally designated by the numeral 33, which may be such as wall 34. The pole 32 is held in a bracket 35, which is mounted to the support 33 by any suitable fastening means. The pole 32 may be of a single or multiple piece construction. Preferably, the pole 32 consists of an upper pole section 36 and a lower pole section 37, which are slidably fitted together and held in position by snap button(s) 38. Snap button(s) 38 may also be used at the lower end 37A of the lower pole section 37 to prevent rotation of the pole 32 in the bracket 35. Suitable openings are provided in the bracket 35 to accept the snap button(s) 38.

The flag 95 may be held to the pole 32 by an upper snap and snap clamp assembly 40, and a lower snap and snap clamp assembly 41, which are well known in the art. A flag anti-wrap device generally designated by the numeral 42, may be placed anywhere between the upper snap and snap clamp assembly 40 and the lower snap and snap clamp assembly 41.

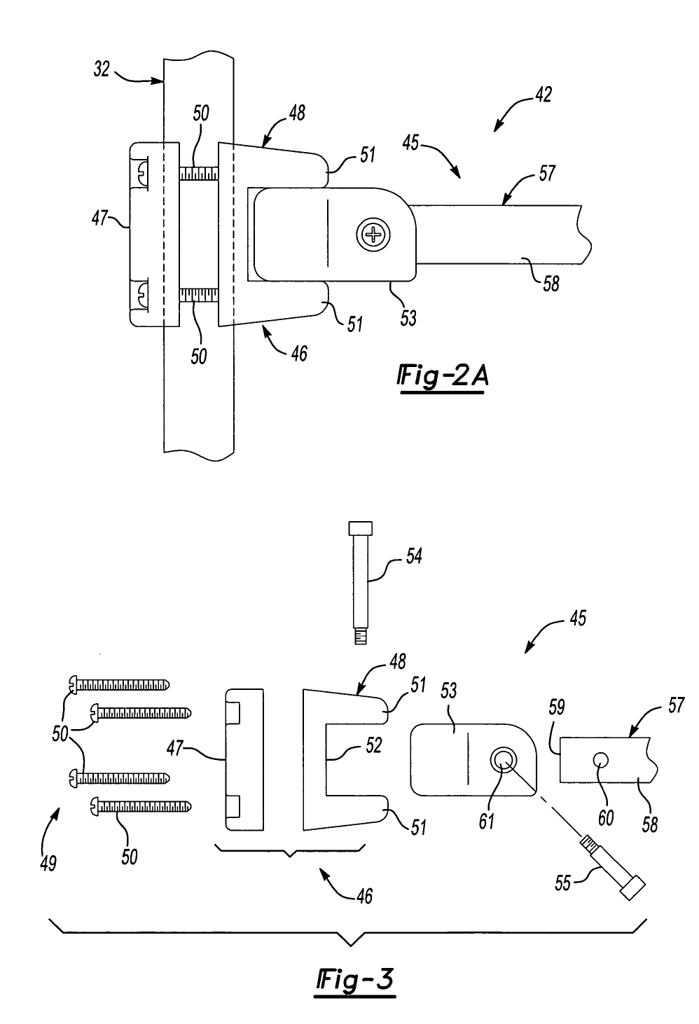

Referring to FIGS. 2A and 3, to mount the flag anti-wrap device 42 to the pole 32, an adjustably fixable clamp 46 is provided which may be fixed in any desired location on a pole as herein above explained. The adjustably fixable clamp 46 consists of a clamping portion 47, and a hinge portion 48, held together by fastening means 49, such as sheet metal screws 50. It is well within the scope of the present invention to use fastening means 49 other than the sheet metal screws 50 to provide for the adjustable fixable clamp to fit a wide range of diameters of flagpole 32.

The hinge portion 48 of the adjustably fixable clamp 46 comprises a pair of spaced apart arms 51, connected by a connecting portion 52, which accepts an arm hinge 53. The arm hinge rotates about a pivot 54 for a predetermined desired degree of rotation. The degree of rotation is determined by when the arm hinge 53 contacts the connecting portion 52 of the hinge portion 48. It can be seen that the connecting portion 52 of the hinge portion 48 may be made to provide for different degrees of rotation of the arm hinge 53 about the pivot 54. Also, it can be seen that the axis of rotation of the arm hinge 53 about the pivot 54 is offset from the axis of the flagpole 32, but is substantially parallel thereto.

Pivotally mounted to the arm hinge 53, for rotation about an axis which is orthogonal to the axis of the pivot 54, is the flag retaining arm or support 57.

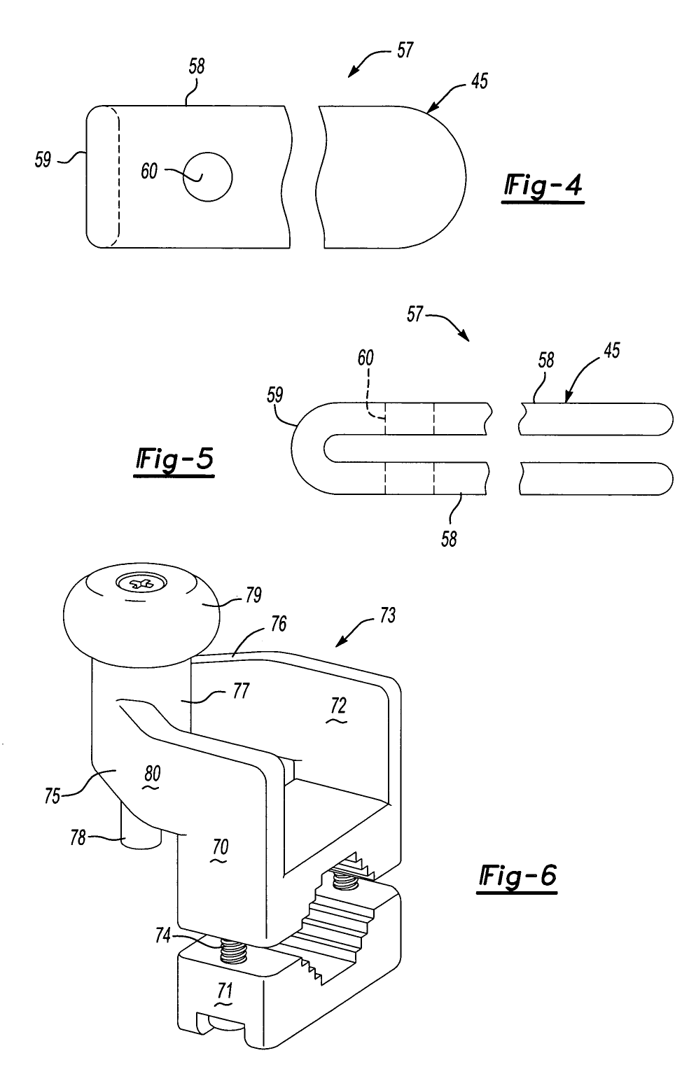

As shown in FIGS. 4 and 5, the flag arm 57 comprises a pair of spaced apart retaining arms 58, which may be similar to the arms 58, shown in FIGS. 1 and 1A, adapted to be placed one on each side of a flag, such as flag 95 shown in FIG. 2. However, in the present invention, the retaining arms 58 are connected at one end by a joining portion 59. Provided adjacent the joining portion 59 of the flag arm 57 is a flag arm aperture 60 which aligns with the arm hinge aperture 61 to accept a second pivot 55 which allows the flag arm 57 to pivot about the second pivot 55 in a plane which is orthogonal to the plane in which the arm hinge 53 pivots. It is preferable that the flag arm 57 rotate for approximately 90° of rotation from a first position substantially parallel to the flagpole to a second position at substantially a right angle to a flagpole. It can be seen that when the flag arm 58 is in a position substantially perpendicular to the axis of the flagpole on which it is mounted, the flag arm 57 will turn with the flag for an amount equal to the degree of rotation of the arm hinge 53, and then will resist further rotation of the flag 95 so that the flag 95 cannot follow or wrap around the pole 36 on which it is mounted. The cross-section of each of the retaining arms 58 may vary with the distance from the connection portion 59 to provide different degrees of resistance or a pre-determined desired resistance to further rotation of the flag 31 once the arm hinge 53 reaches it pre-determined limits of travel.

It is preferable that the flag arm 57 may be made of a transparent strong material such as clear plastic, preferably polycarbonate. However, it can be understood by those skilled in the other materials may be substituted for polycarbonate and be well within the scope of the present invention.

With reference to FIG. 6, it is desirable that the flagpole 32 not rotate within the bracket 35. In a modification of the present invention, there is shown a universal pole latch, generally designated by the numeral 70, which contains a pole latch clamp portion 71, which may be similar or identical to clamping portion 47 of adjustably fixable clamp 46, or different, as the application requires. Mounted opposite the universal pole latch clamp portion 71, is the body portion 73 which is held to the clamping portion 71 by sheet metal screws 74 or other fastening means. The body portion 73 has arms 72 and 80 that have angled portions 75, 76 extending at an angle thereto. At the juncture of angled portion 75 and 76, is a barrel portion 77 having a plunger 78 which is preferably, but not necessarily, spring loaded and reciprocally movable in the barrel portion 77. A knob 79 is attached at one end thereof. To prevent rotation of the flagpole 32, the universal pole clamp 36 would be mounted to the flagpole 32 a short distance above the lower end 37A thereof, and the plunger 78 would fit in the same hole in the bracket 35 that the spring button 38 fit into. If the flag anti-wrap device is being retrofitted in a situation where there is not a hole in bracket 35 for the plunger 68 to fit into, the owner of the flagpole may simply drill a hole in the bracket 35 so that the plunger 68 will fit therein and prevent rotation of the flagpole.

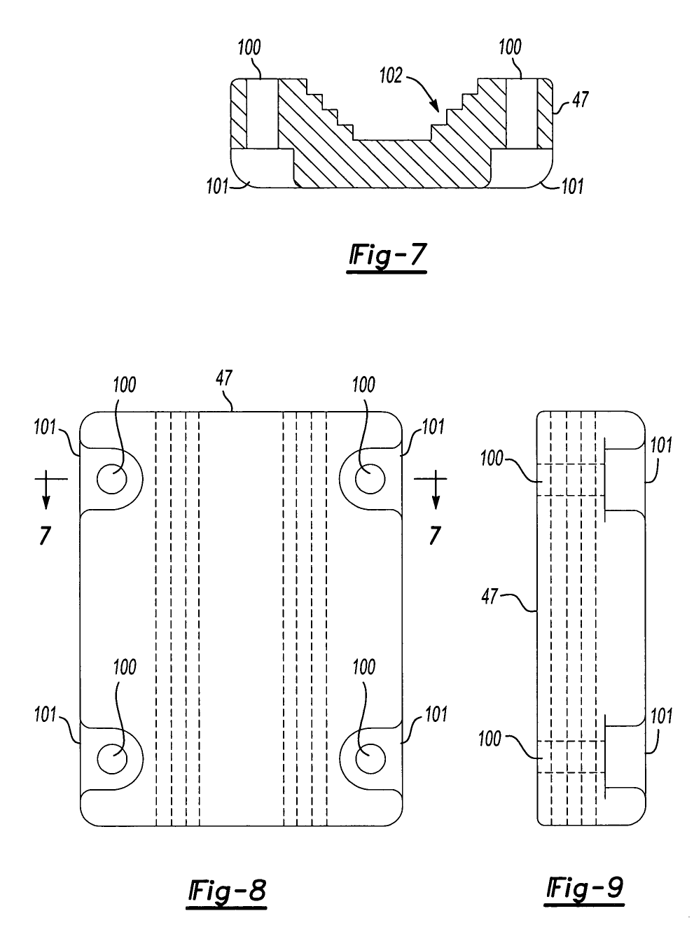

FIGS. 7-9 show an embodiment of the clamp portion 47 of the adjustably fixable clamp 46 of the embodiment shown in FIGS. 2, 2A and 3 above. In this embodiment the clamp portion 47 has apertures 100 with recesses 101 for the fastening means 49, preferably sheet metal screws. A recessed portion 102 is depicted (preferably with a stepped contour) for connecting to the flagpole 32.

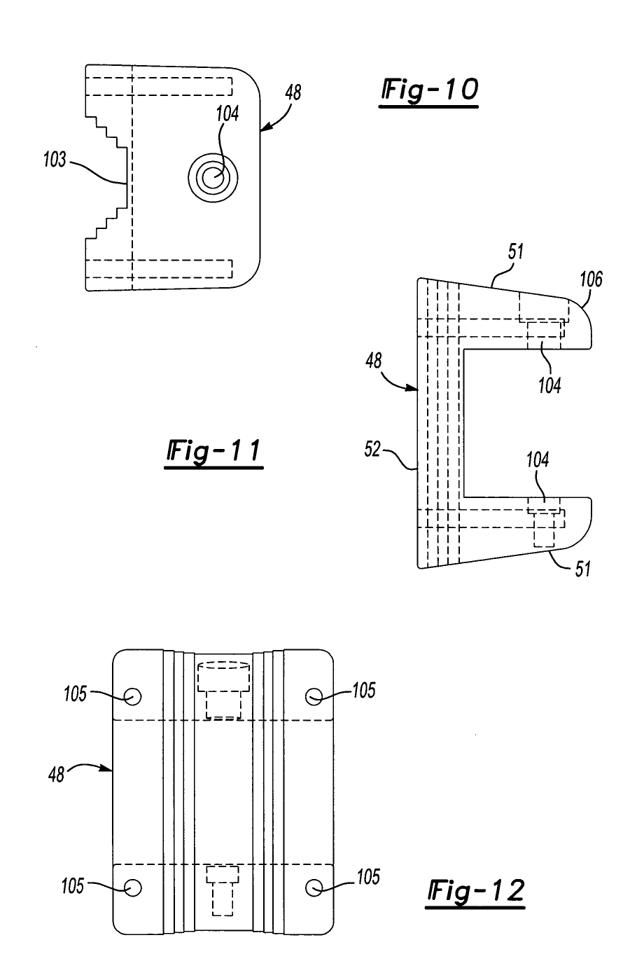

FIGS. 10-12 depict an embodiment of the hinge portion 48 of the adjustably fixable clamp 46 shown in FIGS. 2A and 3. The hinge portion 48 includes a recessed portion 103 (preferably with a stepped contour), which aligns with the recessed portion 102 of clamp portion 47 to connect and to secure the anti-wrap device to the flagpole. Apertures 105 align with apertures 100 (FIG. 8) of the clamping portion 47 for the fastening means 49.

Also depicted is pivot hole 104 with recess 106 for receiving the pivot 54. The configuration depicted allows for the pivot 54 to be in the form of a shoulder bolt (not shown) although other configurations of the pivot are possible within the scope of the present invention. The shoulder bolt is preferred for its ease of assembly.

FIGS. 13-16 depict an embodiment of the arm hinge 53 in accordance with an embodiment of the present invention. Flag arm aperture 61 is shown with a recessed portion 108 for receiving the second pivot 55. The second pivot 55 is again, preferably, in the form of a shoulder bolt. It can be seen that arm hinge 53 preferably has extending side portions 109 that extend on either side of the flag arm 57. Additionally, a center portion 110 preferably extends between the retaining arms 58 of the flag arm 57 to help secure the retaining arms 58 relative to each other and the arm hinge 53, thus sandwiching each of the flag arms 58 between the center portion 110 and one of the extending portions 109. Finally, a connecting portion or base 111 connects both of the extending portions and the center portion. Aperture 107 aligns with pivot hole 104 to accept pivot 54 and retain arm hinge 53 in position.

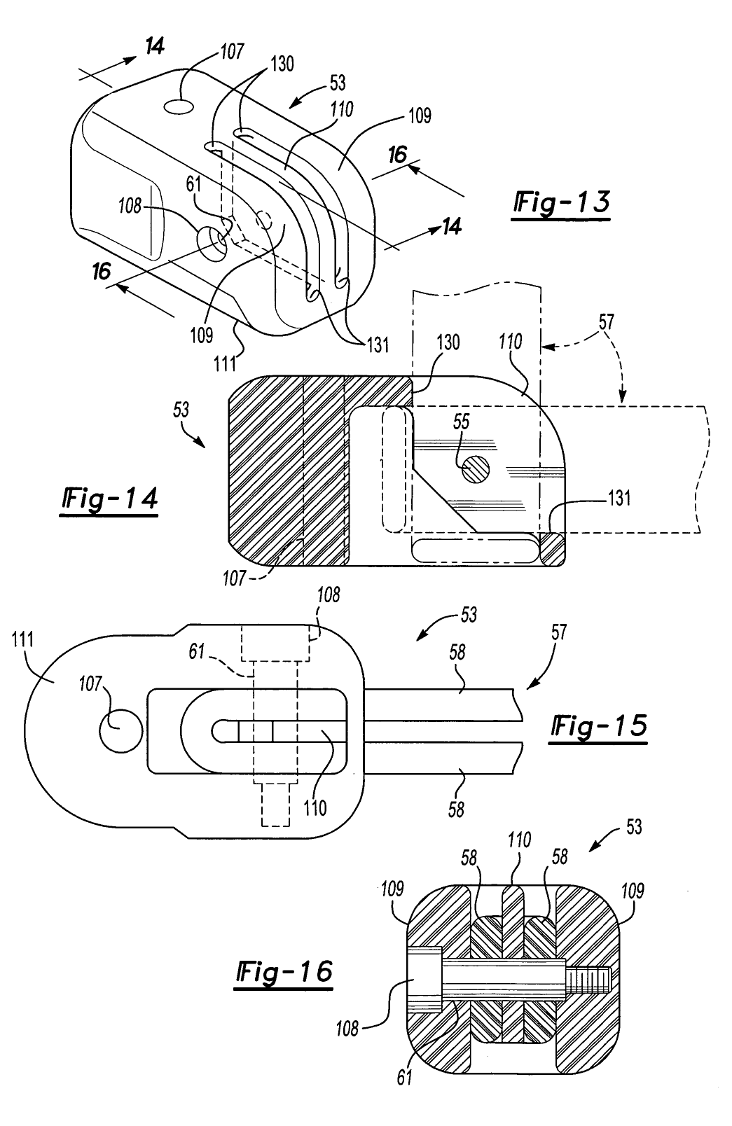

It can best be seen in FIG. 14 that flag arm 57 is restrained to rotate 90° in the preferred embodiment of the invention because of the upper stop portion 130 and the lower stop portion 131 of the arm hinge 53. As the flag arm 57 rotates around the second pivot 55, when it reaches a vertical position, it will be abutting upper stop portion 130, and when it reaches a horizontal position, it will be abutting lower stop portion 130. It can be seen that by varying the proportions of the stop portions (130,131) more or less rotation of the flag arm 57 may be provided for. It is preferred that when the flag arm 57 is in a vertical position it may be slid out the bottom of arm hinge 53, such as for installation in, or removal from, the arm hinge 53.

Thus, by carefully studying the problem associated with flags or banners wrapping around or following the pole on which they are mounted, a novel flag anti-wrap device has been developed. In accordance with the present invention, the anti-wrap device, as shown hereinabove, can be secured to a flagpole. The device can allow the flag to rotate a predetermined amount relative to the flagpole and prevent the flag from wrapping around the flagpole.

In accordance with the provisions of the patent statutes, the invention has been described in what is considered to represent its preferred embodiments. However, it should be noted that the invention can be practiced otherwise than as specifically illustrated and described without departing from its spirit or scope.

1. An anti-wrap device for a flag comprising:
a clamp, which is configured to attach the anti-wrap device to a flagpole;
said clamp comprising a pair of spaced apart arms and a connecting portion, connecting said pair of spaced apart arms;
a first pivot disposed between said pair of spaced apart arms on an axis which, when said clamp is mounted to a flagpole, will be parallel, but offset, from the axis of the flagpole;
an arm hinge rotatably disposed about said first pivot, said arm hinge being configured to have a limited and predetermined range of motion about said first pivot;
a second pivot disposed through said arm hinge;
a flag arm comprising first and second spaced apart retaining arms, which are connected together by a joining portion;
wherein said retaining arms are configured to be disposed on either major face of a flag and said retaining arms are pivotable about said second pivot in a direction substantially orthogonal to the direction of pivot of the am hinge about said first pivot.

2. The anti-wrap device according to claim 1, wherein said clamp comprises:
a clamping portion and a hinged portion; and
fasteners to connect said clamping portion and said hinged portion;
wherein said pair of spaced apart arms and said joining portion are a part of said clamping portion.

3. The anti-wrap device according to claim 2, wherein said fasteners comprise screws.

4. The anti-wrap device according to claim 1, wherein said pair of spaced apart retaining arms and said joining portion comprise clear plastic.

5. The anti-wrap device according to claim 1, wherein said first pivot comprises a stainless steel shaft.

6. The anti-wrap device according to claim 1, wherein said second pivot comprises a stainless steel shaft.

7. The anti-wrap device according to claim 1, wherein the predetermined range of motion of said arm hinge is determined by contact between said arm hinge and said clamp.

8. The anti-wrap device according to claim 1, wherein the rotation of said flag arm is limited by contact with said arm hinge.

9. The anti-wrap device according to claim 1, wherein said arm hinge comprises first and second extending portions parallel to one another with the second pivot being substantially perpendicular to said extending portions.

10. The anti-wrap device according to claim 9, wherein said arm hinge comprises a third extending portion parallel to and between said first and second extending portion, wherein an end of one of said pair of retaining arms is disposed between said first extending portion and said third extending portion, and an end of the other of said pair of retaining arms is disposed between said second extending portion and said third extending portion.

11. The anti-wrap device according to claim 10, wherein said arm hinge comprises a connecting portion, connecting said first, second and third extending portions.

12. The anti-wrap device according to claim 11, wherein said connecting portion of said arm hinge limits rotation of said flag arm.
